(19) United States
(12) Patent Application Publication
(10) Pub. No.: US 2015/0206649 A1
(43) Pub. Date: Jul. 23, 2015

(54) IMPROVED STRUCTURE OF SMD (SURFACE MOUNT DEVICE) TYPE SIGNAL TRANSFORMER

(71) Applicant: KINNEXA, INC., TAIPEI CITY (TW)

(72) Inventor: KUAN-HSIUNG WEI, Taipei City (TW)

(73) Assignee: KINNEXA, INC., TAIPEI CITY (TW)

(21) Appl. No.: 14/161,709

(22) Filed: Jan. 23, 2014

(51) Int. Cl. H01F 27/34; H01F 27/29; H01F 17/04

(52) U.S. Cl. CPC H01F 27/34; H01F 17/04; H01F 27/292

(57) ABSTRACT

An improved structure of an SMD (Surface Mount Device) includes a magnetic core and a plurality of conductive wire. The magnetic core has two ends each forming a connection portion and the connection portion has a side forming at least four soldering sections. The conductive wires are wound around the magnetic core and two ends of each of the conductive wires are respectively soldered to the soldering sections. The conductive wires are subjected to a mechanized automatic winding operation. The magnetic core is an SMD core. With such an arrangement, the volume of the signal transformer can be greatly reduced. Further, an advantage of human-labor-free manufacture can be achieved with the mechanized winding operation and also, the quality of the signal transformer is made more stable to increase the throughput. Advantages including stable electric characteristics, fully automatized manufacture, and high throughput, can be achieved.

### TECHNICAL FIELD OF THE INVENTION

The present invention generally relates to a structure of an SMD (Surface Mount Device) type signal transformer, and more particularly to an improved structure of SMD type signal transformer that has stable electric characteristics, can be manufactured in a fully automatized manner, and has a high throughput.

### DESCRIPTION OF THE PRIOR ART

A signal transformer is often used in a network connection port for the purposes of handling various influences, such as suppressing EMI (Electromagnetic Interference) and reducing signal attenuation. With the signal transformer, such influences are minimized to ensure the quality of networks.

A conventional signal transformer used in a network connection port is often of a configuration having a ring-shaped core, whereby with conductive wire wound around the ring-shaped core, as well as subsequent induction and use, the above purposes of suppressing EMI and reducing signal attenuation can be achieved.

However, most of the conventional signal transformer are manufacturing through manually winding the wire. Human labor cannot effectively controls the quality (such as tightness and arrangement density of the conductive wires), so that the electric characteristics cannot be controlled. Further, the operation speed of a manufacturing operator must be increased in order to increase the throughput. When time becomes slim, the quality can be more difficult to control.

Further, a ring-shaped core is generally not possible to reduce the size thereof, making it not possible to down size the entire network connection port. In the mainstream of miniaturization and thinning of electronic products, improvements on any tiny details are necessary.

Thus, it is a direction for the manufacturers of the industry to devote themselves in studying and research to address the problems and shortcomings of the conventional signal transformers.

### SUMMARY OF THE INVENTION

In view of the above-discussed problems, the present invention aims to provide an improved structure of an SMD (Surface Mount Device) type signal transformer that has stable electrical characteristics, can be manufactured in a fully automatized manner, and has a high throughput.

The primary object of the present invention is as follows. A plurality of conductive wires are wound around an I-shaped SMD magnetic core and ends of the conductive wires are connected to soldering sections formed on connection portions. With such an arrangement, the problems of the conventional signal transformer that the quality cannot be effectively controlled and the throughput cannot be raised can be overcome to achieve the practical advantages of having stable electric characteristics, being manufactured in a fully automatized manner, and having a high throughput.

To achieve the object, the present invention comprises a magnetic core and a plurality of conductive wire wound around the magnetic core. The magnetic core has two ends each forming a connection portion and the connection portion has a side forming at least four soldering sections. The conductive wires each have two ends respectively soldered to the soldering sections. The conductive wires are subjected to a mechanized automatic winding operation. The magnetic core is an I-shaped SMD magnetic core. To manufacture, machines are used to automatically wind the conductive wire around the magnetic core so as to achieve the purpose of controlling electrical characteristics and fully automatized high throughput. Thus, with such an arrangement, the signal transformer of the present invention provides practical advantages of stable electric characteristics, fully automatized manufacture, and high throughput.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a preferred embodiment of the present invention.

FIG. 2 is a cross-sectional view of the preferred embodiment of the present invention.

FIG. 3 is a perspective view showing a magnetic core of the preferred embodiment of the present invention.

FIG. 4 is another perspective view showing the magnetic core of the preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

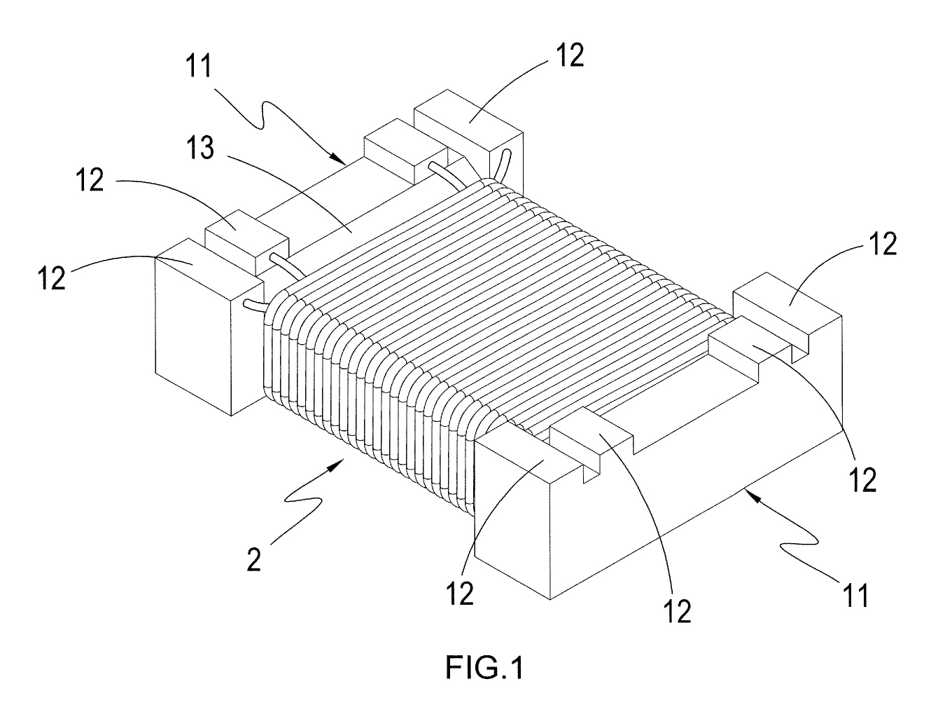

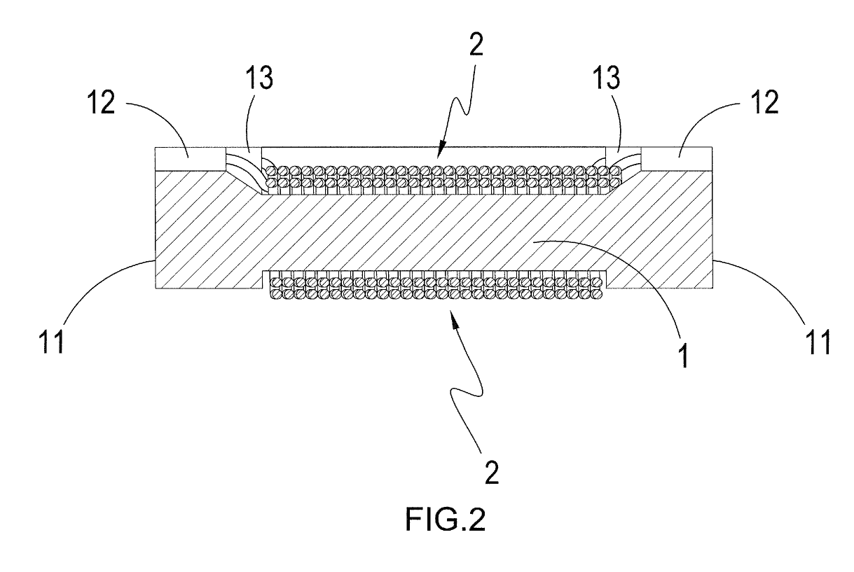

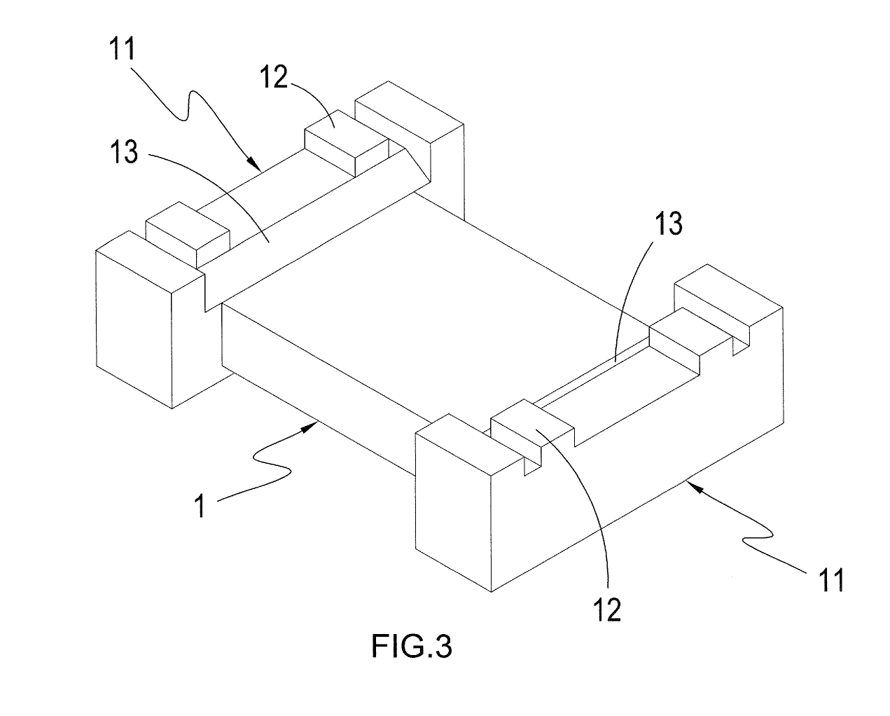

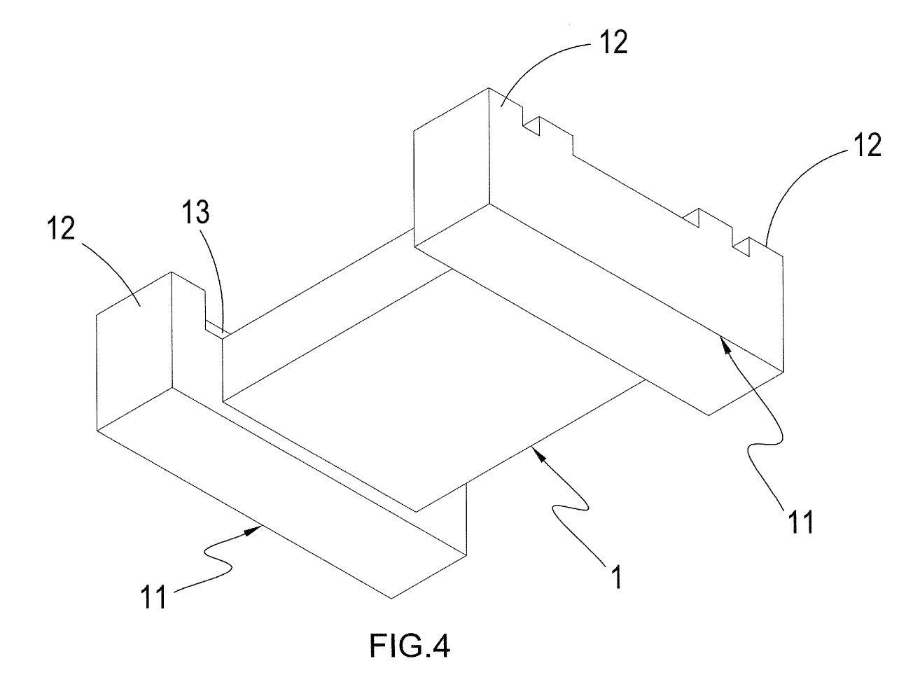

Referring to FIGS. 1, 2, 3, and 4, which are respectively a perspective view and a cross-sectional view showing a preferred embodiment of the present invention and two perspective views showing a magnetic core of the preferred embodiment of the present invention, the drawings clearly show the present invention comprises:

a magnetic core 1, wherein the magnetic core 1 has two ends each forming a connection portion 11 and the connection portion 11 having a side forming at least four soldering sections 12; and

a plurality of conductive wires 2 wound around the magnetic core 1, two ends of each of the conductive wires 2 being respectively connected to the soldering sections 12.

The magnetic core 1 is an SMD (Surface Mount Device) magnetic core and the magnetic core 1 has an I-shaped configuration and the connection portions 11 each form a guide section 13.

With the above description of the structure, together with reference made to the drawings, as well as description given below, the features and the advantages of the present invention can be appreciated, wherein the conductive wires 2 are subjected to a mechanized automatic winding operation to tightly wind around a central section of the magnetic core 1. As such, through the mechanized automatic winding, it is possible to ensure the winding quality (such as details regarding to winding turns and layers of stacking of windings) of the conductive wires 2 of each signal transformer so as to control the electric characteristics of each signal transformer. Afterwards, the two ends of each conductive wire 2 are respectively soldered to the soldering sections 12 of the connection portions 11 at the two ends of the magnetic core 1 to complete the manufacture thereof. Due to the arrangement of the guide sections 13, the conductive wires 2 can be smoothly connected to the soldering sections 12. Further, due to the arrangement of the connection portions 11, the conductive wires 2 are constrained in the central section of the magnetic core 1 thereby making the entirety aesthetic. Using a mechanized manner to wind the conductive wires 2 around the magnetic core 1 can achieve the purposes of precisely controlling thereby achieving the practical advantages of having stable electric characteristics, being manufactured in a fully automatized manner, and having a high throughput.

Thus, the key technique that the improved structure of the SMD type signal transformer can improve the prior art techniques is as follows:

The conductive wires 2 of the magnetic core 1 are subjected to a winding through a mechanized winding operation and the conductive wires 2 are constrained in the central section of the magnetic core 1 by the connection portions 11 so as to achieve the purposes of controlling thereby achieving the practical advantages of having stable electric characteristics, being manufactured in a fully automatized manner, and having a high throughput.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An SMD (Surface Mount Device) signal transformer, comprising:
a magnetic core, wherein the magnetic core has two ends each forming a connection portion and the connection portion has a side forming at least four soldering sections; and
a plurality of conductive wires wound around the magnetic core, two ends of each of the conductive wires being respectively connected to the soldering sections.

2. The SMD signal transformer according to claim 1, wherein the magnetic core is an SMD core.

3. The SMD signal transformer according to claim 1, wherein the magnetic core has an I-shaped configuration.

4. The SMD signal transformer according to claim 1, wherein the connection portions each has a guide section.
